(19) United States
(12) Patent Application Publication
(10) Pub. No.: US 2021/0035253 A1
(43) Pub. Date: Feb. 4, 2021

(54) DEVICES AND METHODS FOR PROCESSING SERVICE REQUEST

(71) Applicant: BEIJING DIDI INFINITY TECHNOLOGY AND DEVELOPMENT CO., LTD., Beijing (CN)

(72) Inventor: Beibei ZHANG, Beijing (CN)

(73) Assignee: BEIJING DIDI INFINITY TECHNOLOGY AND DEVELOPMENT CO., LTD., Beijing (CN)

(21) Appl. No.: 17/019,400

(22) Filed: Sep. 14, 2020

Related U.S. Application Data
(63) Continuation of application No. PCT/CN2019/078166, filed on Mar. 14, 2019.

(30) Foreign Application Priority Data
Mar. 14, 2018 (CN) 201810209735.3

(51) Int. Cl. G06Q 50/30; G06Q 20/10

(52) U.S. Cl. CPC G06Q 50/30; H04W 4/20; G06Q 20/102

(57) ABSTRACT

The present disclosure relates to a method for processing a service request. The method may include receiving, from a first user device, a service request and an amount of power of the first user device via a network. The service request may include a departure location and a destination. The amount of power of the first user device may be not greater than a threshold. The method may also include transmitting the service request to at least one provider terminal via the network, and receiving an order response from a provider terminal of the at least one provider terminal via the network. The method may further include generating order acceptance information based on the order response of the provider terminal, and transmitting the order acceptance information to the first user device and a second user device associated with the first user device via the network.

### CROSS-REFERENCE TO RELATED APPLICATIONS

This application is a continuation of International Application No. PCT/CN2019/078166, filed on Mar. 14, 2019, which claims priority of Chinese Application No. 201810209735.3, filed on Mar. 14, 2018, the contents of each of which are hereby incorporated by reference in its entirety.

### TECHNICAL FIELD

The present disclosure generally relates to online to offline (O2O) services, and in particular, to devices and methods for processing a service request transmitted by a user device when the user device is in low power.

### BACKGROUND

Online-to-offline (O2O) services (e.g., car-hailing services, etc.) are becoming increasingly popular in daily life. A user initiates a car-hailing service by sending a service request (or a car-hailing order) to a server via his/her user device. The server may transmit the service request to a service provider terminal. When a driver associated with the service provider terminal accepts the service request, the server may transmit order acceptance information to the user device. When the amount of power of the user device is sufficient, the user device can be used to communication with the server in real-time to obtain real-time order information (e.g., the real-time bill, the real-time mileage). Upon the completion of the car-hailing service, the user device can be used to pay the bill for the car-hailing service. However, if the amount of power of the user device is low, it is desirable to reduce the interaction between the user device and the server saving the power. In this case, how to complete a service request is worth consideration.

### SUMMARY

In one aspect of the present disclosure, a car-hailing order processing method is provided. The car-hailing order processing method may include receiving a car-hailing order transmitted by a first user device and an amount of power of the first user device. The car-hailing order may include a departure location and a destination. The amount of power of the first user device may be less than or equal to a predetermined threshold. The car-hailing order processing method may also include transmitting the car-hailing order to a driver terminal, and receiving an order response from the driver terminal. The car-hailing order processing method may further include generating order acceptance information based on the order response, and transmitting the order acceptance information to the first user device and a second user device associated with the first user device.

In some embodiments, the car-hailing order processing method may include transmitting a bill of the car-hailing order to the second user device after the car-hailing order is completed.

In some embodiments, the car-hailing order processing method may further include transmitting the bill of the car-hailing order to the first user device, and receiving bill confirmation transmitted by the first user device. The car-hailing order processing method may further include transmitting a payment request for the car-hailing order to the second user device so that the second user device pays the bill based on the payment request.

In another aspect of the present disclosure, a car-hailing method is provided. The car-hailing method may include obtaining a departure location, a destination, and an amount of power of a user device; and generating a car-hailing order based on the departure location and the destination. The car-hailing method may also include, if the amount of power of the user device is less than or equal to the predetermined threshold, transmitting the amount of power of the user device and the car-hailing order to a server.

In some embodiments, after transmitting the amount of power of the user device and the car-hailing order to the server, the car-hailing method may further include receiving order acceptance information of the car-hailing order transmitted by the server. The car-hailing method may further include receiving a bill of the car-hailing order transmitted by the server and transmitting bill confirmation to the server so that the server transmits a payment request for the car-hailing order to a second user device associated with the user device. The second user device may be configured to pay the bill based on the payment request.

In some embodiments, before receiving the bill of the car-hailing order transmitted by the server and transmitting the bill confirmation to the server, the car-hailing method may further include obtaining a second user device designated by a user of the user device, and connecting the second user device to the server so that the server correlates the user device and the second user device in advance.

In yet another aspect of the present disclosure, a car-hailing order processing device is provided. The car-hailing order processing device may be applicable to a server. The car-hailing order processing device may include a first receiving module configured to receive a car-hailing order transmitted by a first user device and an amount of power of the first user device. The car-hailing order may include a departure location and a destination. The amount of power of the first user device may be less than or equal to a predetermined threshold. The car-hailing order processing device may also include a first transmission module configured to transmit the car-hailing order to a driver terminal, and receive an order response from the driver terminal. The first transmission module may also be configured to generate order acceptance information based on the order response, and transmit the order acceptance information to the first user device and a second user device associated with the first user device.

In yet another aspect of the present disclosure, a car-hailing device is provided. The car-hailing device may be applicable to a user device. The car-hailing device may include a generation module configured to obtain a departure location, a destination, and an amount of power of a user device, and generate a car-hailing order based on the departure location and the destination. The car-hailing device may also include a fifth transmission module configured to, if the amount of power of the user device is less than or equal to the predetermined threshold, transmit the amount of power of the user device and the car-hailing order to a server.

In yet another aspect of the present disclosure, a computing device for an online to offline service is provided. The computing device may include at least one storage device, and at least one processor in communication with the at least one storage device. The at least one storage device may include a set of instructions for processing a service request. When executing the set of instructions, the at least one processor may be directed to receive, from a first user device, a service request and an amount of power of the first user device via a network. The service request may include a departure location and a destination. The amount of power of the first user device may be not greater than a threshold. The at least one processor may also be directed to transmit the service request to at least one provider terminal via the network, and receive an order response from a provider terminal of the at least one provider terminal via the network. The at least one processor may be further directed to generate order acceptance information based on the order response of the provider terminal; and transmit the order acceptance information to the first user device and a second user device associated with the first user device via the network.

In yet another aspect of the present disclosure, a user device for an online to offline service is provided. The user device may include at least one storage device, and at least one processor in communication with the at least one storage device. The at least one storage device may include a set of instructions for transmitting a service request. When executing the set of instructions, the at least one processor may be directed to obtain an amount of power of the user device, and determine a service request based on a departure location and a destination. The at least one processor may also be directed to if the amount of power of the user device is not greater than a threshold, transmit the service request and the amount of the user device to a computing device, and receive order acceptance information from the computing device.

In yet another aspect of the present disclosure, a method is provided. The method may be implemented on a computing device having at least one processor, at least one storage medium, and a communication platform connected to a network. The method may include receiving, from a first user device, via the network, a service request and an amount of power of the first user device. The service request may include a departure location and a destination. The amount of power of the first user device may be not greater than a threshold. The method may also include transmitting the service request to at least one provider terminal via the network, and receiving an order response from a provider terminal of the at least one provider terminal via the network. The method may further include generating order acceptance information based on the order response of the provider terminal, and transmitting the order acceptance information to the first user device and a second user device associated with the first user device via the network.

In yet another aspect of the present disclosure, a method is provided. The method may be implemented on a computing device having at least one processor, at least one storage medium, and a communication platform connected to a network. The method may include obtaining an amount of power of the user device, and determining a service request based on a departure location and a destination. The method may also include, if the amount of power of the user device is not greater than a threshold, transmitting the service request and the amount of the user device to a computing device, and receiving order acceptance information from the computing device.

In yet another aspect of the present disclosure, a non-transitory computer-readable storage medium is provided. The non-transitory computer-readable storage medium may embody a computer program product. The computer program product may include instructions configured to cause a computing device to receive, from a first user device, via a network, a service request and an amount of power of the first user device. The service request may include a departure location and a destination. The amount of power of the first user device may be not greater than a threshold. The computer program product may also include instructions configured to cause the computing device to transmit the service request to at least one provider terminal via the network, and receive an order response from a provider terminal of the at least one provider terminal via the network. The computer program product may also include instructions configured to cause the computing device to generate order acceptance information based on the order response of the provider terminal, and transmit the order acceptance information to the first user device and a second user device associated with the first user device.

In yet another aspect of the present disclosure, a non-transitory computer-readable storage medium is provided. The non-transitory computer-readable storage medium may embody a computer program product. The computer program product may include instructions configured to cause a computing device to obtain an amount of power of the user device, and determine a service request based on a departure location and a destination. The computer program product may also include instructions configured to cause the computing device to, if the amount of power of the user device is not greater than a threshold, transmit the service request and the amount of the user device to a computing device, and receive order acceptance information from the computing device.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline (O2O) service system according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device on which a terminal may be implemented according to some embodiments of the present disclosure;

FIG. 4 is a flowchart illustrating an exemplary process for car-hailing order processing according to some embodiments of the present disclosure;

FIG. 5 is a flowchart illustrating an exemplary process for car-hailing according to some embodiments of the present disclosure;

FIG. 6 is a schematic diagram illustrating an exemplary device for car-hailing order processing according to some embodiments of the present disclosure; and

FIG. 7 is a schematic diagram illustrating an exemplary device for car-hailing according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Embodiments of the present disclosure may be applied to different transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express.

The application scenarios of different embodiments of the present disclosure may include but not limited to one or more webpages, browser plugins and/or extensions, client terminals, custom systems, intracompany analysis systems, artificial intelligence robots, or the like, or any combination thereof. It should be understood that application scenarios of the system and method disclosed herein are only some examples or embodiments. Those having ordinary skills in the art, without further creative efforts, may apply these drawings to other application scenarios. For example, other similar server.

The term “passenger,” “requester,” “requestor,” “service requester,” “service requestor” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a requester, a passenger, a driver, an operator, or the like, or any combination thereof. In the present disclosure, “requester” and “requester terminal” may be used interchangeably, and “provider” and “provider terminal” may be used interchangeably.

The term “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

An aspect of the present disclosure provides devices and methods for processing a service request. From a first user device via a network, using the devices and methods of the present application, a service request and an amount of power of the first user device may be received. The service request may include a departure location and a destination. The amount of power of the first user device may be not greater than a threshold (e.g., 5% of a total battery capacity). The service request may be transmitted to at least one provider terminal and an order response from a provider terminal of the at least one provider terminal may be received via the network. Using the devices and methods, order acceptance information may be generated based on the order response of the provider terminal, and the order acceptance information may be transmitted to the first user device and a second user device associated with the first user device via the network.

Another aspect of the present disclosure provides devices and methods for transmitting a service request. Using the devices and methods, an amount of power of the user device may be obtained, and a service request may be determined based on a departure location and a destination. If the amount of power of the user device is not greater than a threshold (e.g., 5% of a total battery capacity), the service request and the amount of the user device may be transmitted to a computing device. Using the devices and methods, order acceptance information may be received from the computing device.

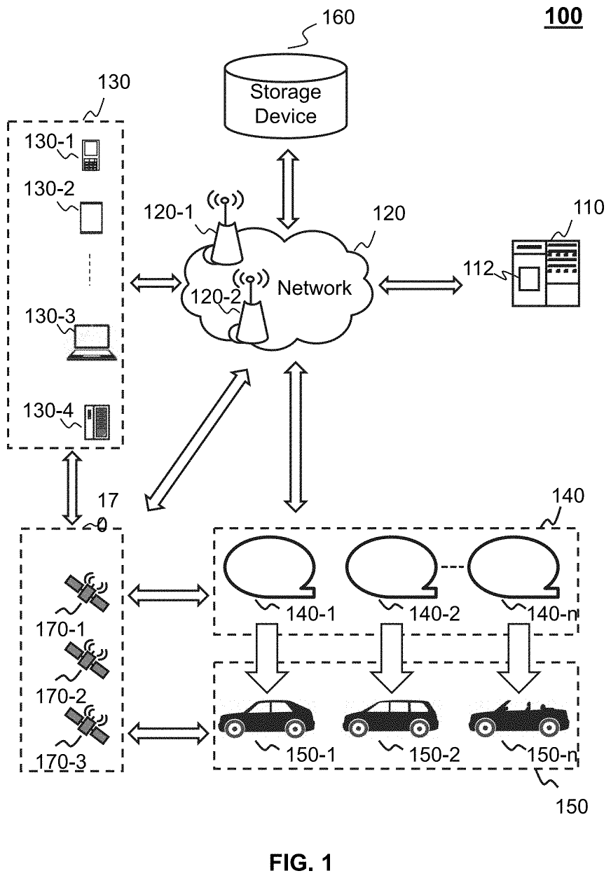

FIG. 1 is a block diagram illustrating an exemplary O2O service system 100 according to some embodiments of the present disclosure. For example, the O2O service system 100 may be an online transportation service platform for transportation services. The O2O service system 100 may include a server 110, a network 120, a requester terminal 130, a provider terminal 140, a vehicle 150, a storage device 160, and a navigation system 170.

The O2O service system 100 may provide a plurality of services. Exemplary service may include a taxi-hailing service, a chauffeur service, an express car service, a carpool service, a bus service, a driver hire service, and a shuttle service. In some embodiments, the O2O service may be any online service, such as booking a meal, shopping, or the like, or any combination thereof.

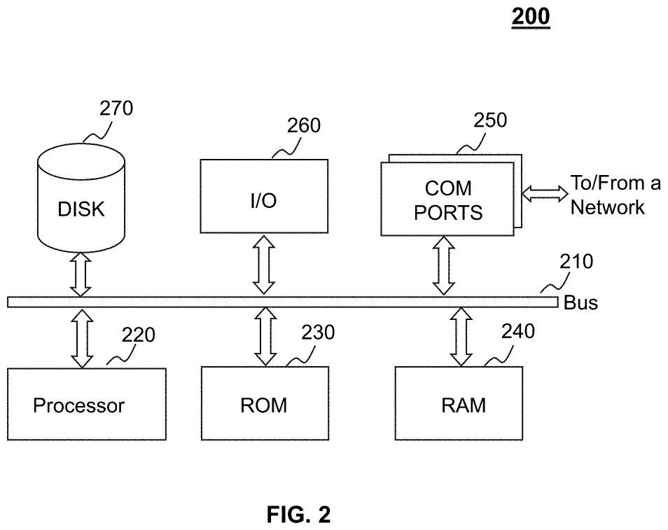

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 160 via the network 120. As another example, the server 110 may be directly connected to the requester terminal 130, the provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. In some embodiments, the processing device 112 may include one or more processing engines (e.g., single-core processing engine(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

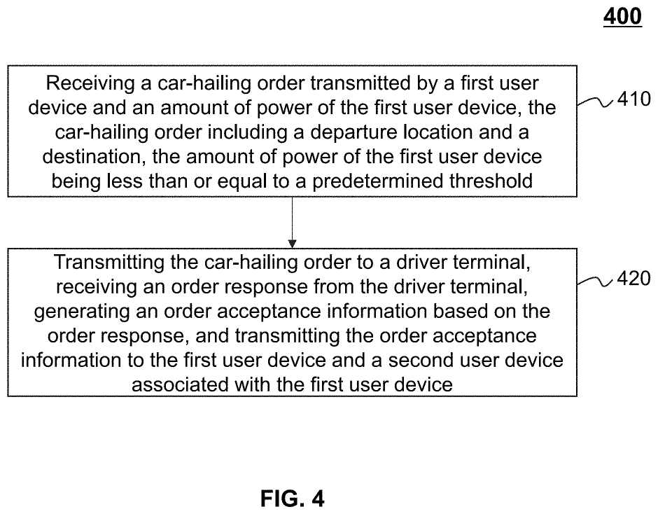

In some embodiments, the processing device 112 may be configured to process a service request. Specifically, the processing device 112 may receive a service request and an amount of power of a first user device (e.g., the requester terminal 130) from the first user device via the network 120. The service request may include a departure location and a destination. In some embodiments, the departure location and/or the destination may be represented by coordinates (e.g., latitude-longitude coordinates), or by a name of a building or a name of a street, or the like. In some embodiments, the service request may also include other information such as a departure time, a number of passengers, a vehicle type, a service type, whether to accept carpool, or the like. The amount of power of the first user device may be not greater than a threshold. The threshold may refer to a specific value relative to total battery capacity of the first user device. For example, the threshold may be 3%, 5%, 7%, 10%, 12%, etc. of the total battery capacity of the first user device. The processing device 112 may transmit the service request to at least one provider terminal (e.g., the provider terminal 140) via the network 120, and receive an order response of a provider terminal of the at least one provider terminal via the network 120. In some embodiments, the processing device 112 may generate order acceptance information based on the order response of the provider terminal. In some embodiments, two or more driver terminals respond to the car-hailing order, the processing device 112 may select one driver terminal among the two or more driver terminals, and generate the order acceptance information based on the order response of the selected driver terminal. The processing device 112 may then transmit the order acceptance information to the first user device and a second user device associated with the first user device via the network 120. An account of the first user device and an account of the second user device may be correlated by the processing device 112 in advance. In some embodiments, the processing device 112 may transmit a bill of the service request to the second user device after the service request is completed so that the second user device pays the bill. Alternatively, the processing device 112 may transmit the bill of the service request to the first user device after the service request is completed so that the first user device confirms the bill. After receiving the bill confirmation from the first user device, the processing device 112 may transmit the bill of the service request to the second user device so that the second user device pays the bill. More descriptions of processing the service request (also referred to as car-hailing order) may be found elsewhere in the present disclosure (e.g., FIG. 4 and the descriptions thereof).

The network 120 may facilitate exchange of information and/or data. In some embodiments, one or more components of the O2O service system 100 (e.g., the server 110, the requester terminal 130, the provider terminal 140, the vehicle 150, the storage device 160, and the navigation system 170) may transmit information and/or data to other component(s) of the O2O service system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the O2O service system 100 may be connected to the network 120 to exchange data and/or information.

In some embodiments, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably. In some embodiments, the provider terminal may be associated with one or more service providers (e.g., a night-shift service provider, or a day-shift service provider).

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift, a HoloLens, a Gear VR, etc. In some embodiments, the built-in device in the vehicle 130-4 may include an onboard computer, an onboard television, etc. In some embodiments, the requester terminal 130 may be a device with positioning technology for locating the position of the passenger and/or the requester terminal 130.

In some embodiments, the requester terminal 130 may also be referred to as a user device. The user device (i.e., the requester terminal 130) may include a second processing device 132. In some embodiments, the second processing device 132 may include one or more processing devices (e.g., single-core processing engine(s) or multi-core processor(s)). Merely by way of example, the second processing device 132 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

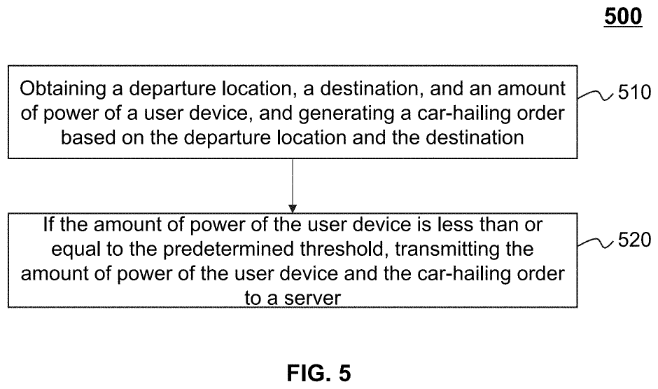

In some embodiments, the second processing device 132 may be configured to transmit a service request when the amount of power of a user device (e.g., the requester terminal 130) is low. Specifically, the second processing device 132 may obtain an amount of power of the user device (e.g., the requester terminal 130). The second processing device 132 may determine a service request based on a departure location and a destination. In some embodiments, the departure location and/or the destination may be inputted via a character input device (e.g., a keyboard, a touchscreen) of the user device, or a microphone of the user device. In some embodiments, the departure location may be automatically determined by the GPS (e.g., the navigation system 170) installed in the user device. If the amount of power of the user device is not greater than a threshold, the second processing device 132 may transmit the service request and the amount of the user device to a computing device (e.g., the server 110), and receive order acceptance information from the computing device. In some embodiments, the second processing device 132 may obtain a second user device designated by the user device. The “designated by the user device” may refer to being designated by a user of the user device. In some embodiments, the second user device may be similar to the user device, or have the same functions as the user device. A user of the second user device may be a relative of the user of the user device. The second processing device 132 may connect the second user device to the computing device so that the computing device correlates the user device and the second user device. For example, the computing device may correlate an account of the user device and an account of the second user device. In some embodiments, the second processing device 132 may receive a bill of the service request from the computing device, and transmit bill confirmation to the computing device so that the computing device transmits the bill of the service request to the second user device. The second user device may be configured to pay the bill. More descriptions of transmitting the service request (also referred to as car-hailing) may be found elsewhere in the present disclosure (e.g., FIG. 5 and the descriptions thereof).

The provider terminal 140 may include a plurality of provider terminals 140-1, 140-2, . . . , 140-n. In some embodiments, the provider terminal 140 may be similar to, or the same device as the requester terminal 130. In some embodiments, the provider terminal 140 may be customized to be able to implement the O2O service 100. In some embodiments, the provider terminal 140 may be a device with positioning technology for locating the service provider, the provider terminal 140, and/or a vehicle 150 associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether a vehicle 150 associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the O2O transportation service 100.

In some embodiments, the provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service).

The storage device 160 may store data and/or instructions. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. In some embodiments, the storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the requester terminal 130, or the provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the requester terminal 130, the provider terminal 140). In some embodiments, the storage device 160 may be part of the server 110.

The navigation system 170 may determine information associated with an object, for example, one or more of the requester terminal 130, the provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may transmit the information mentioned above to the network 120, the requester terminal 130, the provider terminal 140, or the vehicle 150 via wireless connections.

In some embodiments, one or more components of the O2O service system 100 (e.g., the server 110, the requester terminal 130, the provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 130 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 illustrates a schematic diagram of an exemplary computing device according to some embodiments of the present disclosure. The computing device may be a computer, such as the server 110 in FIG. 1 and/or a computer with specific functions, configured to implement any particular system according to some embodiments of the present disclosure. Computing device 200 may be configured to implement any components that perform one or more functions disclosed in the present disclosure. For example, the server 110 may be implemented in hardware devices, software programs, firmware, or any combination thereof of a computer like computing device 200. For brevity, FIG. 2 depicts only one computing device. In some embodiments, the functions of the computing device, providing function that recommending pick-up locations may require, may be implemented by a group of similar platforms in a distributed mode to disperse the processing load of the system.

Computing device 200 may include a communication terminal 250 that may connect with a network that may implement the data communication. Computing device 200 may also include a processor 220 that is configured to execute instructions and includes one or more processors. The schematic computer platform may include an internal communication bus 210, different types of program storage units and data storage units (e.g., a hard disk 270, a read-only memory (ROM) 230, a random-access memory (RAM) 240), various data files applicable to computer processing and/or communication, and some program instructions executed possibly by the processor 220. Computing device 200 may also include an I/O device 260 that may support the input and output of data flows between computing device 200 and other components. Moreover, computing device 200 may receive programs and data via the communication network.

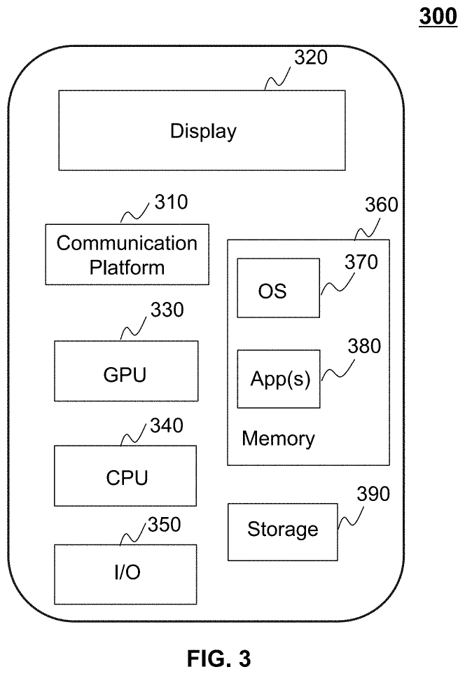

FIG. 3 is a schematic diagram illustrating exemplary hardware and/or software components of an exemplary mobile device on which a terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, a storage 390. In some embodiments, any other suitable component, including but not limited to a system bus or a controller (not shown), may also be included in the mobile device 300.

In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the O2O service system 100. User interactions with the information stream may be achieved via the I/O 350 and provided to the database 130, the server 105 and/or other components of the O2O service system 100. In some embodiments, the mobile device 300 may be an exemplary embodiment corresponding to the requester terminal 130 or the provider terminal 140.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

FIG. 4 is a flowchart illustrating an exemplary process for car-hailing order processing according to some embodiments of the present disclosure. In some embodiments, one or more operations of process 400 may be implemented on the O2O service system 100 as illustrated in FIG. 1, or the computing device 200 as illustrated in FIG. 2, or the mobile device 300 as illustrated in FIG. 3. For example, one or more operations in the process 400 may be stored in the storage device 150 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110). In some embodiments, the instructions may be transmitted in a form of electronic current or electrical signals. For illustration purpose only, the processing device 112 may be described as a subject to perform the process 400.

In 410, the processing device 112 may receive a car-hailing order transmitted by a first user device and an amount of power of the first user device. In some embodiments, the car-hailing order may be also referred to as a service request. The car-hailing order may include a departure location and a destination. The amount of power of the first user device may be less than or equal to a predetermined threshold.

In some embodiments, the departure location and/or the destination may be represented by coordinates (e.g., latitude-longitude coordinates). Alternatively, the departure location and/or the destination may be represented by a name of a community (e.g., a home address of a user), a name of a company (e.g., a work address of the user), a name of a market, a name of a hospital, a name of a bus station, a name of a metro station, a name of a train station, a name of a hotel, a name of food plaza, a name of a scenic area, a name of a street, or the like. In some embodiments, the departure location and/or the destination may be inputted, by the user, via a character input device (e.g., a keyboard, a touch screen) of the first user device or a microphone of the first user device. In some embodiments, the departure location may be automatically determined by the GPS installed in the first user device. In some embodiments, the first user device may be the requester terminal 130 and may include a laptop computer, a mobile phone, a personal digital assistance (PDA), a navigation device, or the like.

In some embodiments, the car-hailing order (or the service request) may also include a departure time, a number of passengers, a vehicle type, a service type, whether to accept carpool, or the like, or any combination thereof. In some embodiments, the vehicle type may include a sedan, a coach, a sports utility vehicle (SUV), a multi-purpose vehicle (MPV), a sports car, a convertible, or the like, or any combination thereof. The service type may include express car, hitchhiking, taxi, special car, or the like, or any combination thereof.

In some embodiments, the predetermined threshold may be a specific value relative to total battery capacity of the first user device. Preferably, the predetermined threshold may be 5% of the total battery capacity of the first user device. It should be noted that the predetermined threshold may also be other percentage (e.g., 3%, 7%, 10%, 15%) of the total battery capacity of the first user device. In some embodiments, the predetermined threshold may be a default value or an empirical value related to the O2O service system 100. Alternatively, the predetermined threshold may be set with different values under different circumstances. For example, in winter, the predetermined threshold may be set to 10% of the total battery capacity of the first user device, while in summer, the predetermined threshold may be set to 5% of the total battery capacity of the first user device.

In 420, the processing device 112 may transmit the car-hailing order to a driver terminal, and receive an order response from the driver terminal. The processing device 112 may generate an order acceptance information based on the order response. The processing device 112 may transmit the order acceptance information to the first user device and a second user device associated with the first user device.

In some embodiments, a user of the second user device may be a relative of the user of the first user device. The processing device 112 may correlate an account of the first user device and an account of the second user device in advance.

In some embodiments, the driver terminal may be the provider terminal 140 and may include a laptop computer, a mobile phone, a personal digital assistance (PDA), a navigation device, a built-in device in a vehicle, or the like. In some embodiments, the processing device 112 may transmit the car-hailing order to a plurality of driver terminals. If only one driver terminal responds to the car-hailing order, the processing device 112 may generate an order acceptance information based on the order response. If two or more driver terminals respond to the car-hailing order, the processing device 112 may select one driver terminal among the two or more driver terminals, and generate an order acceptance information based on the order response of the selected driver terminal. The processing device 112 may select the driver terminal randomly, or based on matching degrees between the car-hailing order and driver terminals (such as a distance between a driver terminal and the departure location of the car hailing order, vehicle type, service type, etc.). In some embodiments, the processing device 112 may directly allocate the car-hailing order to a driver terminal to determine an order acceptance information.

In some embodiments, the processing device 112 may transmit a bill of the car-hailing order to the second user device after the car-hailing order is completed so that the second user device pays the bill. Alternatively, the processing device 112 may transmit the bill of the car-hailing order to the first user device, and receive bill confirmation transmitted by the first user device. The processing device 112 may then transmit a payment request for the car-hailing order to the second user device so that the second user device pays the bill based on the payment request. Merely by way of example, the second user device may pay the bill by performing the following operations: connecting a payment application (e.g., Alipay™, WeChat™, E-bank), inputting a password, making the payment, ending the payment, jumping to an order details page, or the like.

In some embodiments, after receiving the bill confirmation transmitted by the first user device, the processing device 112 may transmit a payment request for the car-hailing order to the first user device so that the first user device pays the bill based on the payment request.

It can be understood that, after receiving the bill confirmation transmitted by the first user device, a payment request for the car-hailing order may be transmitted to the second user device, so that the second user device pays the bill. In this case, after the driver of the driver terminal picks up the user of the first user device (or after the car-hailing order is completed), the first user device may only receive the bill of the car-hailing order, and confirm the bill of the car-hailing order. The first user device may not need to pay the bill, which may save the amount of power of the first user device.

The process 400 for car-hailing order processing in the present disclosure may be applicable to a server (e.g., the server 110). When an amount of power of the first user device is less than or equal to a predetermined threshold, a car-hailing order and the amount of power of the first user device may be received by the server. The car-hailing order may be transmitted, by the server, to a driver terminal, and an order response may be received, by the server, from the driver terminal. An order acceptance information may be generated, by the server, based on the order response. The order acceptance information may be transmitted, by the server, to the first user device and a second user device associated with the first user device, so that the second user device pays a bill for the car-hailing order, thereby saving the amount of power of the first user device. It shall be noted that the communication between the server and the first user device, the second user device, or the driver terminal may be achieved via a network (e.g., the network 120).

It should be noted that the above description regarding the process 400 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, if the amount of power of the first user device is greater than the predetermined threshold, the processing device 112 may also transmit the bill of the car-hailing order to the second user device after the car-hailing order is completed so that the second user device pays the bill.

FIG. 5 is a flowchart illustrating an exemplary process for car-hailing according to some embodiments of the present disclosure. In some embodiments, one or more operations of process 500 may be implemented on the O2O service system 100 as illustrated in FIG. 1, or the computing device 200 as illustrated in FIG. 2, or the mobile device 300 as illustrated in FIG. 3. For example, one or more operations in the process 500 may be stored in the storage device 150 and/or the storage (e.g., the ROM 230, the RAM 240, etc.) as a form of instructions, and invoked and/or executed by the requester terminal 130 (e.g., the second processing device 132 in the requester terminal 130). In some embodiments, the instructions may be transmitted in a form of electronic current or electrical signals. For illustration purpose only, the second processing device 132 may be described as a subject to perform the process 500.

In 510, the second processing device 132 may obtain a departure location, a destination, and an amount of power of a user device. The second processing device 132 may generate a car-hailing order based on the departure location and the destination. The car-hailing order may also be referred to as a service request.

In some embodiments, the process 500 for car-hailing in the present disclosure may be applicable to a user device carried by a user.

In some embodiments, the departure location and/or the destination may be represented by coordinates (e.g., latitude-longitude coordinates), or by a name of a building or a name of a street, etc. In some embodiments, the departure location and/or the destination may be inputted, by the user, via a character input device (e.g., a keyboard, a touchscreen) of the user device or a microphone of the user device. In some embodiments, the departure location may be automatically determined by the GPS installed in the user device. In some embodiments, the car-hailing order (or the service request) may also include a departure time, a number of passengers, a vehicle type, a service type, whether to accept carpool, or the like, or any combination thereof.

In some embodiments, the predetermined threshold may be a specific value relative to total battery capacity of the user device. Preferably, the predetermined threshold may be 5% of the total battery capacity of the user device. It should be noted that the predetermined threshold may also be other percentage (e.g., 3%, 7%, 10%, 15%) of the total battery capacity of the user device. More descriptions of the predetermined threshold may be found elsewhere in the present disclosure (e.g., operation 410 of process 400 and the relevant descriptions thereof).

In 520, the second processing device 132 may transmit the amount of power of the user device and the car-hailing order to a server if the amount of power of the user device is less than or equal to the predetermined threshold.

In some embodiments, the second processing device 132 may further receive order acceptance information of the car-hailing order transmitted by the server. The second processing device 132 may also receive a bill of the car-hailing order transmitted by the server, and transmit bill confirmation to the server so that the server transmits a payment request for the car-hailing order to a second user device associated with the user device. The second user device may be configured to pay the bill based on the payment request.

It can be understood that, the user device may only display the order acceptance information of the car-hailing order and may not need to communicate with the server in real-time, which may save the amount of power of the user device. The order acceptance information may be a static cached page and shows that car-hailing has been succeeded and is waiting for the driver. The second user device may communicate with the driver via the driver terminal in real-time.

In some embodiments, the second user device may pay the bill by performing the following operations: connecting a payment application (e.g., Alipay™, WeChat™, E-bank), inputting a password, making the payment, ending the payment, jumping to an order details page, or the like.

In some embodiments, after transmitting the bill confirmation to the server, the second processing device 132 may also receive a payment request for the car-hailing order from the server and pay the bill based on the payment request.

It can be understood that, the second processing device 132 may receive the bill of the car-hailing order transmitted by the server, and transmit bill confirmation to the server so that the server transmits a payment request for the car-hailing order to a second user device associated with the user device. The second user device may pay the bill based on the payment request. In this case, after the driver of the driver terminal picks up the user of the user device (or after the car-hailing order is completed), the user device may only receive the bill of the car-hailing order, and confirm the bill of the car-hailing order. The user device may not need to pay the bill, which may save the amount of power of the user device.

In some embodiments, before receiving the bill of the car-hailing order transmitted by the server and transmitting the bill confirmation to the server, the second processing device 132 may obtain a second user device designated by the user of the user device, and connect the second user device to the server so that the server correlates the user device and the second user device in advance.

In some embodiments, a user of the second user device may be a relative of the user of the user device. The second processing device 132 may correlate an account of the user device and an account of the second user device in advance.

The device for car-hailing (or the car-hailing device 700) in the present disclosure may be applicable to a user device. When the amount of power of the user device is less than or equal to the predetermined threshold, the interaction between the user device and the server may be reduced and the number of invoked applications may also be reduced. The user device may only provide the departure location, the destination and the bill confirmation. The second user device associated with the user device may communicate with the server to display the real-time information (e.g., the real-time bill) and to pay the bill when the car-hailing order is completed. Thus, when the amount of power of the user device is less than or equal to the predetermined threshold, the second user device may pay the bill for the car-hailing order, which may save the amount of power of the user device.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, regardless of whether the amount of power of the user device is greater than the predetermined threshold or not, the second processing device 132 may transmit the amount of power of the user device and the car-hailing order to a server.

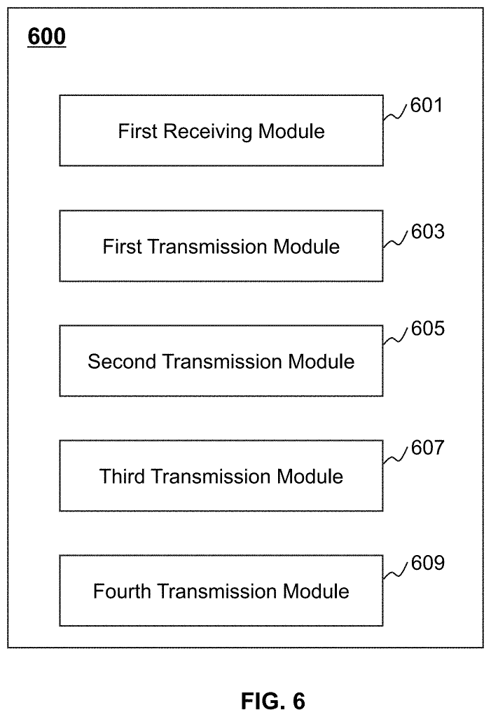

FIG. 6 is a block diagram illustrating an exemplary device for car-hailing order processing according to some embodiments of the present disclosure. The device 600 (also referred to as the car-hailing order processing device 600) may be applicable to a server. As shown in FIG. 6, the car-hailing order processing device 600 may include a first receiving module 601, a first transmission module 603, a second transmission module 605, a third transmission module 607, and a fourth transmission module 609.

In some embodiments, the modules of the device 600 may be hardware circuits of all or part of the processing device 112. The modules of the device 600 may also be implemented as an application or set of instructions read and executed by the processing device 112. Further, the modules may be any combination of the hardware circuits and the application/instructions. For example, the modules may be the part of the processing device 112 when the processing device 112 is executing the application/set of instructions.

The first receiving module 601 may be configured to receive a car-hailing order transmitted by a first user device and an amount of power of the first user device. The car-hailing order may include a departure location and a destination. The amount of power of the first user device may be less than or equal to a predetermined threshold.

The first transmission module 603 may be configured to transmit the car-hailing order to a driver terminal, and receive an order response from the driver terminal. The first transmission module 603 may also be configured to generate order acceptance information based on the order response, and transmit the order acceptance information to the first user device and a second user device associated with the first user device.

Specifically, the first receiving module 601 may receive a car-hailing order transmitted by a first user device and an amount of power of the first user device. The car-hailing order may include a departure location and a destination. The amount of power of the first user device may be less than or equal to a predetermined threshold. The first transmission module 603 may transmit the car-hailing order to a driver terminal, and receive an order response from the driver terminal. The first transmission module 603 may also generate order acceptance information based on the order response, and transmit the order acceptance information to the first user device and a second user device associated with the first user device.

In some embodiments, the departure location and/or the destination may be represented by coordinates (e.g., latitude-longitude coordinates).

Preferably, the predetermined threshold may be 5% of the total battery capacity of the first user device. It should be noted that the predetermined threshold may also be other percentage (e.g., 3%, 7%, 10%, 15%) of the total battery capacity of the first user device.

The second transmission module 605 may be configured to transmit a bill of the car-hailing order to the second user device after the car-hailing order is completed.

The third transmission module 607 may be configured to transmit the bill of the car-hailing order to the first user device.

The fourth transmission module 609 may be configured to receive bill confirmation transmitted by the first user device, and transmit a payment request for the car-hailing order to the second user device so that the second user device pays the bill based on the payment request.

In some embodiments, the second user device may pay the bill by performing the following operations: connecting a payment application (e.g., Alipay™, WeChat™, E-bank), inputting a password, making the payment, ending the payment, jumping to an order details page, or the like.

In some embodiments, after receiving the bill confirmation transmitted by the first user device, the fourth transmission module 609 may transmit a payment request for the car-hailing order to the first user device so that the first user device pays the bill based on the payment request.

It can be understood that, after receiving the bill confirmation transmitted by the first user device, the fourth transmission module 609 may transmit a payment request for the car-hailing order to the second user device so that the second user device pays the bill based on the payment request. In this case, after the driver of the driver terminal picks up the user of the first user device (or after the car-hailing order is completed), the first user device may only receive the bill of the car-hailing order, and confirm the bill of the car-hailing order. The first user device may not need to pay the bill, which may save the amount of power of the first user device.

The device for car-hailing order processing (or the car-hailing order processing device 600) in the present disclosure may be applicable to a server (e.g., the server 110). When the amount of power of the first user device is less than or equal to the predetermined threshold, the second user device may pay the bill for the car-hailing order, which may save the amount of power of the first user device.

The device for car-hailing order processing (or the car-hailing order processing device 600) in the present disclosure may be used to perform one or more operations of process 400 as described in FIG. 4. The implementation principle and technical effects of the device 600 may be similar to the process 400, which can refer to the descriptions in FIG. 4 and is not repeated herein.

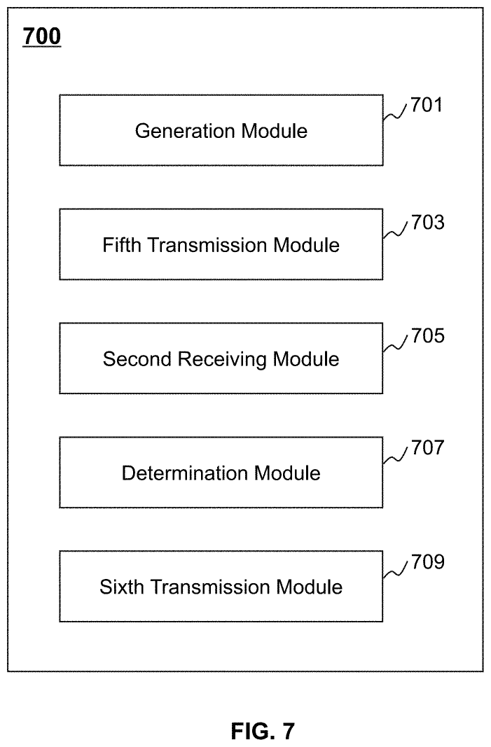

FIG. 7 is a block diagram illustrating an exemplary device for car-hailing according to some embodiments of the present disclosure. The device 700 (also referred to as the car-hailing device 600) may be applicable to a user device. As shown in FIG. 7, the car-hailing device 600 may include a generation module 701, a fifth transmission module 703, a second receiving module 705, a determination module 707, and a sixth transmission module 709.

In some embodiments, the modules of the device 700 may be hardware circuits of all or part of the second processing device 132. The modules of the device 700 may also be implemented as an application or set of instructions read and executed by the second processing device 132. Further, the modules may be any combination of the hardware circuits and the application/instructions. For example, the modules may be the part of the second processing device 132 when the second processing device 132 is executing the application/set of instructions.

The generation module 701 may be configured to obtain a departure location, a destination, and an amount of power of a user device. The generation module 701 may also be configured to generate a car-hailing order based on the departure location and the destination.

The fifth transmission module 703 may be configured to, if the amount of power of the user device is less than or equal to a predetermined threshold, transmit the amount of power of the user device and the car-hailing order to a server.

Specifically, the generation module 701 may obtain a departure location, a destination, and an amount of power of a user device, and generate a car-hailing order based on the departure location and the destination. The fifth transmission module 703 may transmit the amount of power of the user device and the car-hailing order to a server if the amount of power of the user device is less than or equal to a predetermined threshold.

In some embodiments, the departure location and/or the destination may be represented by coordinates (e.g., latitude-longitude coordinates).

Preferably, the predetermined threshold may be 5% of the total battery capacity of the user device. It should be noted that the predetermined threshold may also be other percentage (e.g., 3%, 7%, 10%, 15%) of the total battery capacity of the user device.

The second receiving module 705 may be configured to receive order acceptance information of the car-hailing order transmitted by the server.

The determination module 707 may be configured to receive a bill of the car-hailing order transmitted by the server, and transmit bill confirmation to the server so that the server transmits a payment request for the car-hailing order to a second user device associated with the user device. The second user device may be configured to pay the bill based on the payment request.

It can be understood that, the user device may only display the order acceptance information of the car-hailing order and may not need to communicate with the server in real-time, which may save the amount of power of the user device. The order acceptance information may be a static cached page and shows that car-hailing has been succeeded and is waiting for the driver. The second user device may communicate with the driver via the driver terminal in real-time.

In some embodiments, the second user device may pay the bill by performing the following operations: connecting a payment application (e.g., Alipay™, WeChat™, E-bank), inputting a password, making the payment, ending the payment, jumping to an order details page, or the like.

In some embodiments, after transmitting the bill confirmation to the server, the determination module 707 may also receive a payment request for the car-hailing order from the server and pay the bill based on the payment request.

It can be understood that, the determination module 707 may receive the bill of the car-hailing order transmitted by the server, and transmit bill confirmation to the server so that the server transmits a payment request for the car-hailing order to a second user device associated with the user device. The second user device may pay the bill based on the payment request. In this case, after the driver of the driver terminal picks up the user of the user device (or after the car-hailing order is completed), the user device may only receive the bill of the car-hailing order, and confirm the bill of the car-hailing order. The user device may not need to pay the bill, which may save the amount of power of the user device.

The sixth transmission module 709 may be configured to obtain the second user device designated by a user of the user device, and connect the second user device to the server so that the server correlates the user device and the second user device in advance.

The device for car-hailing (or the car-hailing device 700) in the present disclosure may be applicable to a user device. When the amount of power of the user device is less than or equal to the predetermined threshold, the interaction between the user device and the server may be reduced and the number of invoked applications may also be reduced. The user device may only provide the departure location, the destination and the bill confirmation. The second user device associated with the user device may communicate with the server to display the real-time information (e.g., the real-time bill) and to pay the bill when the car-hailing order is completed. Thus, when the amount of power of the user device is less than or equal to the predetermined threshold, the second user device may pay the bill for the car-hailing order, which may save the amount of power of the user device.

The device for car-hailing (or the car-hailing device 700) in the present disclosure may be used to perform one or more operations of process 500 as described in FIG. 5. The implementation principle and technical effects of the device 700 may be similar to the process 500, which can refer to the descriptions in FIG. 5 and is not repeated herein.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1-12. (canceled)

13. A computing device for an online to offline service, comprising:
at least one storage device including a set of instructions for processing a service request;
at least one processor in communication with the at least one storage device, wherein when executing the set of instructions, the at least one processor is directed to:
receive, from a first user device, via a network, a service request and an amount of power of the first user device, the service request including a departure location and a destination, the amount of power of the first user device is not greater than a threshold;
transmit, via the network, the service request to at least one provider terminal;
receive, via the network, an order response from a provider terminal of the at least one provider terminal;
generate order acceptance information based on the order response of the provider terminal; and
transmit, via the network, the order acceptance information to the first user device and a second user device associated with the first user device.

14. The computing device of claim 13, wherein an account of the first user device and an account of the second user device is correlated.

15. The computing device of claim 13, wherein the at least one processor is further directed to:
transmit a bill of the service request to the second user device after the service request is completed so that the second user device pays the bill.

16. The computing device of claim 15, wherein the at least one processor is further directed to:
transmit the bill of the service request to the first user device after the service request is completed so that the first user device confirms the bill; and
after receiving the bill confirmation from the first user device, transmit the bill of the service request to the second user device so that the second user device pays the bill.

17. A user device for an online to offline service, comprising:
at least one storage device including a set of instructions for transmitting a service request;
at least one processor in communication with the at least one storage device, wherein when executing the set of instructions, the at least one processor is directed to:
obtain an amount of power of the user device;
determine a service request based on a departure location and a destination;
if the amount of power of the user device is not greater than a threshold, transmit the service request and the amount of the user device to a computing device; and
receive order acceptance information from the computing device.

18. The user device of claim 17, wherein the at least one processor is further directed to:
obtain a second user device designated by the user device; and
connect the second user device to the computing device so that the computing device correlates the user device and the second user device.

19. The user device of claim 18, wherein the computing device correlates an account of the user device and an account of the second user device.

20. The user device of claim 18, wherein the at least one processor is further directed to:
receive a bill of the service request from the computing device; and
transmit bill confirmation to the computing device so that the computing device transmits the bill of the service request to the second user device, the second user device being configured to pay the bill.

21. A method implemented on a computing device having at least one processor, at least one storage medium, and a communication platform connected to a network, comprising:
receiving, from a first user device, via the network, a service request and an amount of power of the first user device, the service request including a departure location and a destination, the amount of power of the first user device is not greater than a threshold;
transmitting, via the network, the service request to at least one provider terminal;
receiving, via the network, an order response from a provider terminal of the at least one provider terminal;
generating order acceptance information based on the order response of the provider terminal; and
transmitting, via the network, the order acceptance information to the first user device and a second user device associated with the first user device.

22. The method of claim 21, wherein an account of the first user device and an account of the second user device is correlated.

23. The method of claim 21, further comprising:
transmitting a bill of the service request to the second user device after the service request is completed so that the second user device pays the bill.

24. The method of claim 23, further comprising:
transmitting the bill of the service request to the first user device after the service request is completed so that the first user device confirms the bill; and
after receiving the bill confirmation from the first user device, transmitting the bill of the service request to the second user device so that the second user device pays the bill.

25-30. (canceled)

31. The computing device of claim 13, wherein to determine the provider terminal of the at least one provider terminal, the at least one processor is directed to:
select a certain provider terminal from the at least one provider terminal randomly, or based on a matching degree between the service request and each of the at least one provider terminal.
designate the selected certain provider terminal as the provider terminal.

32. The computing device of claim 14, wherein the second user device is designated by a user of the first user device in advance.

33. The computing device of claim 13, wherein the at least one processor is further directed to:
reduce a number of an interaction between the first user device and the processing device; and
make the second user device to communicate with the provider terminal in real-time.

34. The user device of claim 17, wherein the order acceptance information is generated based on an order response from a provider terminal.

35. The user device of claim 18, wherein the at least one processor is further directed to:
reduce a number of an interaction between the first user device and the processing device; and
make the second user device to communicate with the provider terminal in real-time.

36. The method of claim 21, wherein to determine the provider terminal of the at least one provider terminal, the method further comprising:
selecting a certain provider terminal from the at least one provider terminal randomly, or based on a matching degree between the service request and each of the at least one provider terminal.
designating the selected certain provider terminal as the provider terminal.

37. The method of claim 22, wherein the second user device is designated by a user of the first user device in advance.

38. The method of claim 21, further comprising:
reducing a number of an interaction between the first user device and the processing device; and
making the second user device to communicate with the provider terminal in real-time.
